(19) United States
(12) Patent Application Publication
(10) Pub. No.: US 2013/0113697 A1
(43) Pub. Date: May 9, 2013

(54) DISPLAY CONTROL DEVICE

(71) Applicant: HUI-CHIH CHANG, TAIPEI CITY (TW)

(72) Inventor: HUI-CHIH CHANG, TAIPEI CITY (TW)

(73) Assignee: NUETEQ TECHNOLOGY, INC., TAIPEI CITY (TW)

(21) Appl. No.: 13/290,161

(22) Filed: Nov. 7, 2011

(51) Int. Cl. G09G 5/00

(52) U.S. Cl. 345/156

(57) ABSTRACT

A display control device is disclosed for at least a computer system to control one or more display devices. The display control device includes a processing unit, a memory unit, a connection module, and a video control unit. The memory unit records the display control data generated by the processing unit. The connection module is for connecting the display devices, and for transmitting the video data generated by the computer system when reading the display control data to the display devices. The video control unit is coupled to the computer system, the connection module, and the processing unit. The video control unit is controlled by the processing unit for selecting the display device connected with the connection module, and outputs the video data generated by the computer system to the selected display device through the connection module. Therefore, the computer system may communicate to display devices having different standards.

### BACKGROUND OF THE INVENTION

1. Field of the Invention

The present invention relates to a control device; in particular, to a display control device for controlling display capabilities of a display device.

2. Description of Related Art

In the present day, the technology grows dramatically, thus a lot of management manners of all kinds of computer systems are developed. For example, there is a video splitter or a video matrix for allowing one or more computer systems to connect with one or more video devices. Take the video splitter as an example, it has a connection port for connecting with a computer system, and a video interface connection ports for simultaneously connecting with one or more output devices, such as video display devices. The user may use the video splitter for selecting the connected output device, for allowing the computer system to control the selected output device. However, the output devices connecting with the video splitter may have different sizes and standards. When the video splitter selects any one of the output devices for outputting the information of the computer system, it may need to adjust the format of the outputted information for matching the standard of the selected output device.

### SUMMARY OF THE INVENTION

A display control device is disclosed according to an embodiment of the present invention, for at least one computer system to control one or more display devices having display identification data. The display control device includes a processing unit, a memory unit, a connection module, and a video control unit. The processing unit generates a display control data for controlling display capability of the display device. The memory unit records the display control data generated by the processing unit, for allowing the computer system to be able to read the display control data. The connection module is used for connecting with the display device, and for transmitting a video data which is generated when the computer system reads the display control data to the display device. The video control unit is coupled to the computer system, the connection module, and the processing unit, and is controlled by the processing unit for transmitting the video data generated by the computer system to the display device through the connection module.

On the basis of the above, the display control device provided by the embodiment of the present invention may allow the computer system to communicate with the display devices connected with the display control device. Moreover, the display control device may let the computer system generate the video data according to the display control data in correspondence to the display device, for outputting the video data to the display devices.

For further understanding of the present disclosure, reference is made to the following detailed description illustrating the embodiments and examples of the present disclosure. The description is only for illustrating the present disclosure, not for limiting the scope of the claim.

### BRIEF DESCRIPTION OF THE DRAWINGS

The drawings included herein provide further understanding of the present disclosure. A brief introduction of the drawings is as follows:

FIG. 1 shows a block diagram of a display control device according to an embodiment of the present invention;

FIG. 2 shows a block diagram of another display control device according to an embodiment of the present invention;

FIG. 3 shows a block diagram of still another display control device according to an embodiment of the present invention; and

FIG. 4 shows a structure schematic diagram of a display control device according to an embodiment of the present invention.

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended drawings.

### Embodiment of Display Control Device

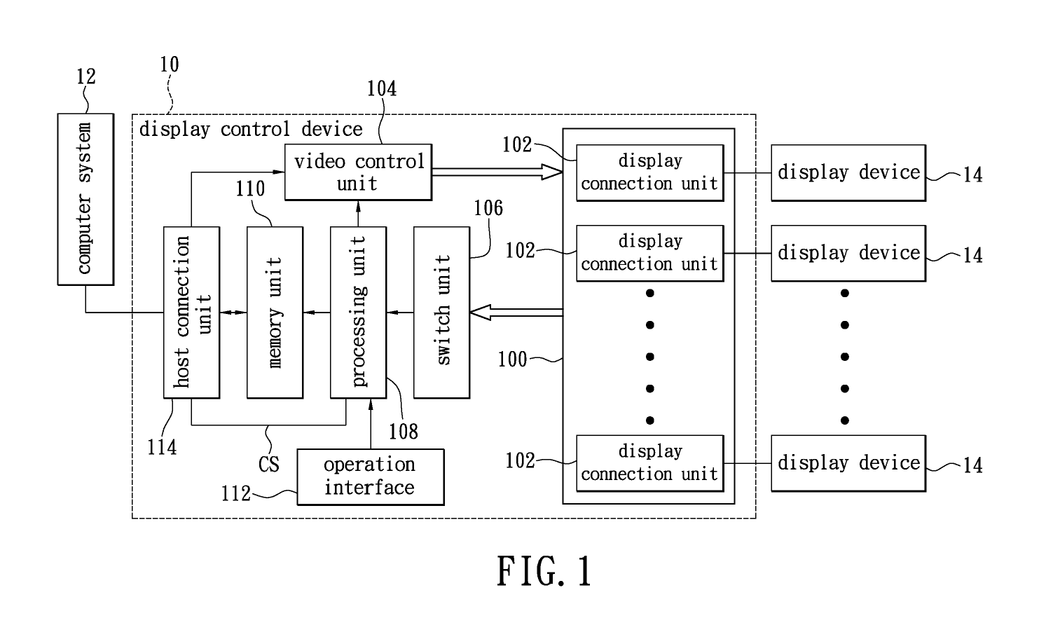

Please refer to FIG. 1 which shows a block diagram of a display control device according to an embodiment of the present invention. The display control device 10 includes a connection module 100, a video control unit 104, a switch unit 106, a processing unit 108, a memory unit 110, an operation interface 112, and a host connection unit 114. The connection module 100 further includes one or more display connection units 102. In this embodiment, the display control device 10 may be a video splitter, for connecting with at least one computer system 12 and one or more display devices 14. Therefore, by using one single main control device (such as the computer system 12 in this embodiment), all of the video output devices (such as the display devices 14 in this embodiment) connecting therewith may be controlled. The computer system 12 may be a desktop computer host, a server, a notebook computer, or a video player (such as DVD player, VCD player, or Blu-ray player), etc. The display device 14 may be a cathode ray tube (CRT) screen, a liquid crystal display (LCD) screen, a light-emitting display (LED) screen, an overhead projector, or other video output devices, etc. In this embodiment, the connection module 100 may be electrically connected with the one or more display devices 14, the video control unit 104, and the switch unit 106. The video control unit 104, the switch unit 106, the memory unit 110, and the operation interface 112 are respectively connected with the processing unit 108. The video control unit 104 and the memory unit 110 are further coupled to the computer system 12.

The one or more display connection units 102 of the connection module 100 may be connected with the display devices 14 one on one. Moreover, the connection module 100 may select the display devices 14 which connect with the display connection units 102 according to the control of the processing unit 108 and the video control unit 104. The connection module 100 in this embodiment may be a video graphics array (VGA) interface module, a digital video interface (DVI) module, a high definition multimedia interface (HDMI) module, or a DisplayPort (DP) interface module. Every display connection unit 102 may be a connection socket in correspondence to the mentioned interface module, for corresponding to the connection plug with the same interface, in order to connect with the display device 14.

The video control unit 104 may be a video integrated circuit (video IC), for receiving the video data transmitted by the computer system 12. According to the control of the processing unit 108, the video control unit 104 may transmit the video data among the display connection units 102, in order to use the display connection units 102 for selecting the display device 14 connecting with the display connection unit 102. Thus, the video data of the computer system 12 may be outputted to the display device 14 connected with the display connection unit 102 for displaying.

Comparing to the video control unit 104 for outputting the video data to the display device 14 connected with the display connection unit 102, the processing unit 108 controls the switch unit 106 for respectively reading the sets of display identification data corresponding to each of the display devices 14. The processing unit 108 may be a central processing unit (CPU), a microcontroller, or an embedded controller, etc., and the switch unit 106 may be a switch circuit. The connection manner for connecting the switch unit 106 with the connection module 100 may let every display connection unit 102 of the connection module 100 be electrically connected with the switch unit 106 through a bus. Thus, the processing unit 108 and the switch unit 106 may serve as masters for reading the sets of display identification data of the display devices 14.

It is worth noting that the contents of the display identification data of the display devices 14 may be different from one another. When the computer system 12 generates the video data, the contents of the video data may be arranged according to the display identification data of the display device 14, in order to prevent the display device 14 from abnormally displaying the data outputted by the computer system 12. The display identification data may usually include a manufacturer data, a display parameter data, a color parameter data, or a refreshing frequency parameter data of the display device 14, such as an extension display identification data (EDID). The EDID is usually stored in the storage unit (not shown in FIG. 1) of the display device 14, such as an electronic erasable programmable read only memory (EEPROM). The display parameter data of the EDID may include maximum viewable width, height, and supported video resolution. The color parameter data may include the gamma value and the suitable color systems (such as RGB or YPbPr, etc.) in correspondence to the display device 14. The refreshing frequency parameter data may include a screen refreshing frequency, a horizontal sync frequency, and a vertical sync frequency, etc. Part of the EDID may further include an audio parameter data (such as the number of the audio channels which can be outputted by the display device 14) or a stereo display parameter data (such as the data which records whether the display device 14 supports 3D video display) of the display device 14. The aforementioned parameters are all associated to the display capabilities of the corresponding display device 14.

The supported types or standards of the display devices 14 may be different. If the video data outputted by the computer system 12 does not be generated according to the parameter contents defined by the display identification data, there may be a display error occurring at the display device 14. For example, if the video data with higher video resolutions is transmitted to the display device 14 with relatively lower video resolutions, the display device 14 may not be able to display the video. On the other hand, if the video data with lower video resolutions is transmitted to the display device 14 with relatively higher video resolutions, the video may be displayed at only part of the viewable region of the display device 14 rather than all of it.

In this embodiment, the processing unit 108 may control the switch unit 106 to switch among the display connection unit 102 for reading the display identification data of different display devices 14. Furthermore, the processing unit 108 may capture and integrate the parameter contents of more than one display identification data from several different display devices 14. After that, a set of display control data is emulated for being provided to the computer system 12 for generating the video data. For example, the most common video resolution and the highest video refreshing frequency parameter among all of the display devices 14 may be selected for being combined into the display control data. Therefore, the display control data may also be used for controlling the display capabilities of the display devices 14. After the computer system 12 acquires the display control data, it may generate suitable video data according to the parameters of the display control data.

In another embodiment, the processing unit 108 may also use the manner which selects and copies one of the read display identification data as the display control data. For example, the display identification data with lowest supporting video resolution may be selected as the display control data, which may ensure that every display devices 14 connected with the display connection unit 102 are able to output the video data properly, and may prevent some display devices 14 from wrongly displaying the video data.

Whatever the display control data is emulated by capturing several display identification data or directly copied from one of the display identification data, it may be transmitted and temporarily stored in the memory unit 110 by the processing unit 108. The memory unit 110 may be a volatile memory or non-volatile memory, such as a random access memory (RAM), an electronic erasable programmable read only memory (EEPROM), or a flash memory, etc. The memory unit 110 may be embedded in the processing unit 108, or be separately disposed from the processing unit 108.

The computer system 12 may connect to display control device 10 through the host connection unit 114 which is further connected with the memory unit 110 and the video control unit 104. The computer system 12 may serve as a main control end and the memory unit 110 may serve as a controlled end. The computer system 12 may read the display control data stored by the processing unit 108 from the memory unit 110, and arrange the standards of the video data according to the parameter content of the display control data, which include resolution or the output frequency of the video data, etc. The video data generated by the computer system 12 is transmitted to the video control unit 104 through the host connection unit 114. After that, because the video control unit 104 may be controlled by the processing unit 108 for selecting the display connection unit 102, the video control unit 104 may transmit the video data to the display device 14 in correspondence to the selected display connection unit 102. Then images of the video data may be displayed on the corresponding display device 14.

It is worth noting that if the host connection unit 114 is a digital video interface unit or a HDMI unit which supports high-bandwidth digital content protection (HDCP) mechanics. Other than reading the EDID recorded by the memory unit 110, the signal channel between the computer system 12 and the host connection unit 114 may also be used for allowing the transmission of the HDCP data, in order to read the EDID of the display device 14. Under this situation, in order to prevent the memory unit 110 and the display device 14 from providing EDID simultaneously, which causes errors at the computer system 12, the processing unit 108 may temporarily stop the transmission of the HDCP data through the control cable CS which is connected with the host connection unit 114. In other words, when the processing unit 108 determines that the computer system 12 reads the display control data recorded by the memory unit 110, it may control the host connection unit 114 to temporarily cut off the connection with the video control unit 104. Thus, the signal channel between the computer system 12 and the host connection unit 114 may only be used for reading the EDID recorded in the memory unit 110. After the computer system 12 reads the EDID recorded in the memory unit 110, the transmission of the HDCP data may be recovered.

The operation interface 112 may be one or more buttons, keys, switches, serial communication interfaces (such as RS232), on screen display (OSD) interfaces, or infrared (IR) communication interfaces. The operation interface 112 may be used for receiving the operations of the users, in order to generate operation commands and transmit the operation commands to the processing unit 108. The processing unit 108 may control the switch unit 106 for switching to one of the display connection units 102 according to the operation commands. For example, the operation interface 112 may be one or more switches, buttons, keys, or combinations thereof, for selecting one of the display devices 14, in order to transmit the EDID of the display device 14 to the memory unit 110. When the user presses one of the buttons, the pressed button may output signal to the processing unit 108. Then the processing unit 108 may control the switch unit 106 for switching to the corresponding display connection unit 102 after determining the pressed button and the corresponding display connection unit 102 according to the sources of the signal. Thus, the EDID of the display device 14 in correspondence to the display connection unit 102 may be read for data capturing or copying.

In another embodiment, the operation interface 112 may be an infrared communication interface, such as an infrared receiving module, for receiving infrared signal and generating the operation command. The user may use remote controller or other remote control devices for sending commands to the display control device 10, and may also make the display control device 10 selects the display device 14 according to the operation command for acquiring corresponding EDID.

In still another embodiment, other than generating the operation commands of the display device 14, the operation interface 112 may also used for controlling the processing unit 108 for adjusting or modifying the display control data temporarily stored in the memory unit 110. Accordingly, the display result of the video data which is sent to the display device 14 may be changed.

Take on screen display (OSD) interface as an example of the operation interface 112, the user may use the menu provided by the OSD interface and the remote controller, for selecting the items in the menu and changing the configuration of the parameters, such as selecting different display devices 14, changing the video resolution, selecting different number of audio channels, changing horizontal or vertical sync frequencies, turning on or off the stereo display functions, or turning on or off the internet connection functions, etc. After receiving the one or more operation commands for changing the display control data, the processing unit 108 may modify the parameters of the display control data recorded in the memory unit 110. Therefore, the computer system 12 may be able to read the modified display control data, for generating the video images which match user requirements.

### Another Embodiment of Display Control Device

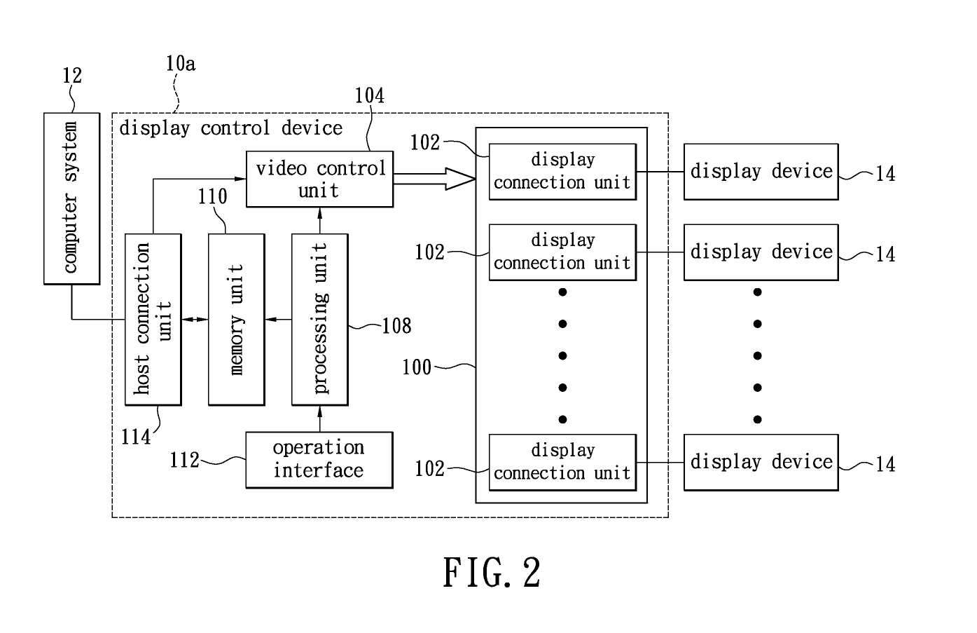

Please refer to FIG. 2 which is a block diagram of a display control device according to another embodiment of the present invention. In this embodiment, the display control device may be a video splitter. Comparing with the display control device 10 in FIG. 1, the display control device 10a does not need to dispose the switch unit 106 between the connection module 100 and the processing unit 108.

In this embodiment, a set of display control data is stored in the memory unit 110 in advance. Thus, the computer system 12 may directly read the stored data through the host connection unit 114 for generating video data. The processing unit 108 receives the operation commands generated by the operation interface 112 according to the operations of the user, and controls the display control unit 104 for switching to the corresponding display connection unit 102 according to the indicated display device 14 selected by the operation commands. Accordingly, the video data which corresponds to the pre-stored display control data may be outputted to the selected display device 14.

In addition, the processing unit 108 may also be used for receiving the operation commands for adjusting the contents of the display control data. According to the adjusted contents, the processing unit 108 may correspondingly modify the contents of the parameters of the display control data recorded in the memory unit 110. Therefore, the video data may be displayed on the correct display device 14 selected according to the user requirements.

In this embodiment, the remaining parts which may be replaced or the same as those in FIG. 1 may not be repeatedly described, and please refer thereto.

### Still Another Embodiment of Display Control Device

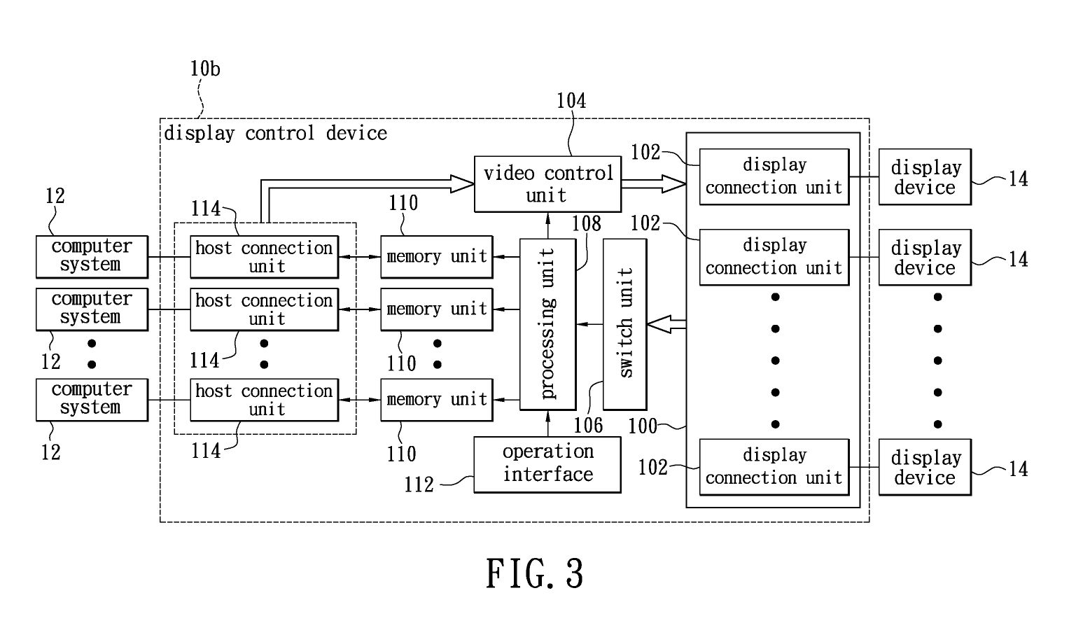

FIG. 3 shows a block diagram of the display control device provided according to still another embodiment of the present invention. The differences between FIG. 3 and FIG. 1 are that the display control device 10b of this embodiment includes several memory units 110 and several host connection units 114. The memory units 110 are connected with the host connection units 114 one on one, and the host connection units 114 are also connected with several computer systems 12. The display control device 10b in this embodiment may be a video matrix.

The processing unit 108 may emulate or copy the display control data from the display identification data of one or more display devices 14 according to embodiment shown in FIG. 1, and may store the display control data into the respective memory units 110. Thus, when any of the computer systems 12 wants to control the display screen of the display device 14, it may read the display control data in the corresponding memory unit 110 through the corresponding host connection unit 114, for generating the video data according to the display control data. The video data generated by the computer system 12 may be transmitted to the video control unit 104 through the host connection unit 114. The host connection unit 114 and the video control unit 104 may communicate with each other by using the buses in the display control device 10b.

Therefore, the display control device 10b not only allows one single computer system 12 to transmit video to several display devices 14, but also allows several computer systems 12 to transmit video to several display devices 14.

In this embodiment, the remaining parts which are replaceable or the same as those of the embodiment in FIG. 1 may not be repeatedly described.

It is worth noting that as shown in FIG. 3, the structure of several host connection units 114 and several computer systems 110 which are connected one on one may also be used in the embodiment of FIG. 2. In the embodiment of FIG. 2, if there are several memory units 110, every memory unit 110 may store one set of display control data in advance, for being read by the respective computer systems 12, in order to generate video data.

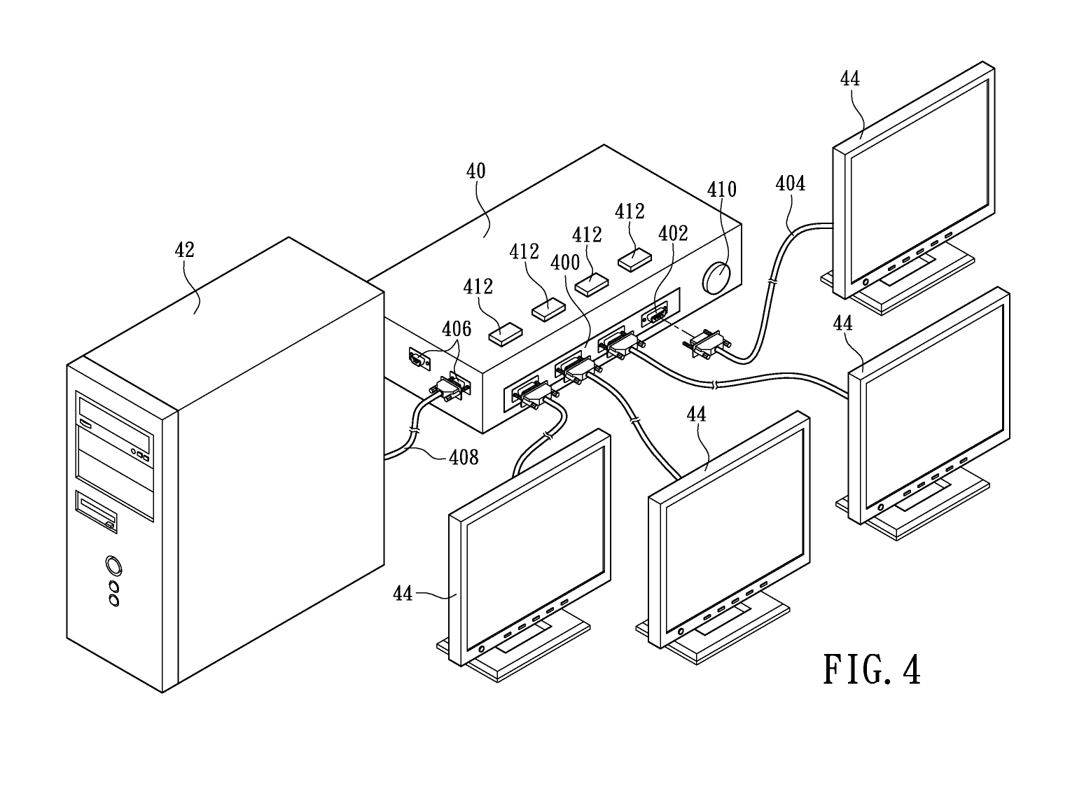

Please refer to FIG. 4 which is a schematic diagram of the display control devices of the aforementioned embodiments. As shown in FIG. 4, the display control device 40 includes a connection module 400 which has several display connection units 402 located on the panel of the chassis. Every display connection unit 402 may be a connection socket, for connecting with several screens 44 one on one through screen connection cable 404.

Besides connecting the display connection unit 102 of the display device 14, there may be one or more host connection units 406 for connecting to the computer host 42 through the host connection cable 408 (corresponding to the computer system 12 of FIG. 1 to FIG. 3).

In addition, the display control device 40 may further include a power switch 410 and several operation keys 412 (which correspond to the operation interface 112 of FIGS. 1 to 3). The operation keys 412 may correspond to the respective display connection units 402. The user may directly press any of the operation keys 412 for choosing the specific screen 44. The operation keys 412 may be displaced to buttons, switches, serial communication interfaces (such as RS-232), screen display interfaces, or infrared communication interfaces.

### Possible Efficiencies of Embodiments

According to the embodiments of the present invention, the aforementioned display control device may be used for allowing at least one computer system to connect with one or more display devices, and may let the computer system generate the video data suitable to the display device according to the display control data processed and analyzed by the processing unit. The video data may be transmitted to one or more display devices through the display control device. Furthermore, the display control device may also allow the computer system to control one or more display devices connected with the display control device. The one input (computer system) to one output (display device), one input to multiple outputs, and multiple inputs to multiple outputs mechanics may be implemented, which makes the user to assign complicated video controls conveniently.

In addition, the display control device may use the switch unit located between the display connection unit and the processing unit for switching different display devices in turns, which allows the processing unit to read the display identification data stored by several display devices. Moreover, the processing unit may be able to integrate several display identification data for emulating the display control data, or may directly select one of the display identification data as the display control data. The display control device may use volatile or non-volatile memory for recording the display control data processed by the processing unit. The combinations of the components may let the computer system flexibly generate video data suitable to the display device according to the display control data.

The display control device may also let the user to directly select one of the display devices connecting with the display control device through the operation interface, which eliminates the un-convenience for installing extra control software. Moreover, the display control device may receive commands through the operation interface, for modifying the display control data in the devices. Thus, the video data which matches different requirements of display devices may be generated accordingly, and may be displayed correctly on every display device.

Some modifications of these examples, as well as other possibilities will, on reading or having read this description, or having comprehended these examples, will occur to those skilled in the art. Such modifications and variations are comprehended within this disclosure as described here and claimed below. The description above illustrates only a relative few specific embodiments and examples of the present disclosure. The present disclosure, indeed, does include various modifications and variations made to the structures and operations described herein, which still fall within the scope of the present disclosure as defined in the following claims

What is claimed is:

1. A display control device for at least one computer system to control one or more display devices, wherein every display device includes a display identification data, comprising:
a processing unit for generating a display control data, wherein the display control data is used for controlling display capability of the display device;
at least one memory unit for recording the display control data generated by the processing unit, for allowing the display control data to be read by the computer system;
a connection module for connecting with the display device, and for transmitting a video data which is generated when the computer system reads the display control data to the display device; and
a video control unit coupled to the computer system, the connection module, and the processing unit, wherein the video control unit is controlled by the processing unit for selecting the display device connected with the connection module, and outputs the video data generated by the computer system to the display device through the connection module.

2. The display control device according to claim 1, wherein the connection module includes a plurality of display connection units used for connecting with the display device one on one.

3. The display control device according to claim 2, wherein the processing unit is coupled to the connection module, and is used for reading and processing the display identification data of the display device connected with the connection module, for generating the display control data and recording the display control data into the memory unit.

4. The display control device according to claim 3, further comprising:
a switch unit connecting between the processing unit and the connection module, wherein the switch unit is controlled by the processing unit for switching among the display devices, in order to allow the processing unit to read the display identification data of the display device which is switched.

5. The display control device according to claim 3, wherein the display control data is one of the display identification data selected and read by the processing unit.

6. The display control device according to claim 3, wherein the processing unit extracts and integrates the display identification data from multiple of the display devices for generating the display control data.

7. The display control device according to claim 2, wherein the connection module is a VGA interface module, a DVI module, a HDMI module, or a DP interface module.

8. The display control device according to claim 4, wherein the display control data includes a display parameter data, a color parameter data, a refreshing frequency parameter data, an audio parameter data, or a stereo display parameter data.

9. The display control device according to claim 8, further comprising:
an operation interface connected with the processing unit, for receiving an operation and generating an operation command accordingly, and for transmitting the operation command to the processing unit;
wherein the processing unit controls the switch unit or changes a content of the display control data according to the operation command.

10. The display control device according to claim 9, wherein the operation interface is a switch, a button, a key, a serial communication interface, a screen display interface, or an infrared communication interface.

11. The display control device according to claim 4, further comprising:
an operation interface connected with the processing unit, for receiving an operation and generating an operation command, and for transmitting the operation command to the processing unit;
wherein the processing unit controls the switch unit or changes a content of the display control data according to the operation command.

12. The display control device according to claim 11, wherein the operation interface is a switch, a button, a key, a serial communication interface, a screen display interface, or an infrared communication interface.

13. The display control device according to claim 1, further comprising:
a host connection unit connected between the memory unit and the video control unit, for connecting with the computer system, and for allowing the computer system to read the display control data recorded in the memory unit.

14. The display control device according to claim 13, wherein the host connection unit is a digital video interface unit or a high definition multimedia interface unit which supports high bandwidth digital content protection data, wherein the processing unit controls the host connection unit to temporarily cut off a transmission of the high bandwidth digital content protection data when the computer system reads the display control data recorded in the memory unit.

15. The display control device according to claim 1, further comprising:
a plurality of host connection units connected with the video control unit, for connecting between multiple of the computer systems and multiple of the memory units one on one;
wherein every computer system reads the display control data of the corresponding memory unit through the corresponding host connection unit.

16. The display control device according to claim 1, wherein the connection module is a VGA interface module, a DVI module, a HDMI module, or a DP interface module.
